(19) United States
(12) Patent Application Publication
(10) Pub. No.: US 2020/0055228 A1
(43) Pub. Date: Feb. 20, 2020

(54) METHOD AND DEVICE FOR PRODUCING PROFILED PLASTIC SECTIONS

(71) Applicant: Thomas STADLHUBER, Gmunden (AT)

(72) Inventor: Thomas STADLHUBER, Gmunden (AT)

(21) Appl. No.: 16/342,928

(22) PCT Filed: Oct. 19, 2017
(86) PCT No.: PCT/AT2017/060272

§ 371 Date: Apr. 17, 2019

(30) Foreign Application Priority Data
Oct. 19, 2016 (AT) A 50946/2016

(51) Int. Cl. B29C 48/90; B29C 48/92; B29C 48/00; B29C 48/88

(52) U.S. Cl. CPC B29C 48/904; B29C 48/92; B29C 48/0022; B29C 48/911; B29C 2948/92923; B29C 48/905; B29C 2948/92704; B29C 2948/926; B29C 48/919

(57) ABSTRACT

The invention relates to a method for producing profiled plastic sections in an extrusion line consisting of multiple tools, wherein a starting material is plasticized and molded in an extruder and then cooled and calibrated in at least one drying calibration unit and at least one calibration tank. The material is then divided into individual profiled sections. The quality of the profiled sections is improved in that a central control unit is provided which is connected to the tools and obtains data from the tools for uniquely identifying the tool and data on the state of the tool and transmits back adjustment data for said tool and other tools.

The invention relates to a method for producing plastic profiles in an extrusion line consisting of several tools, in which a starting material is plasticized and formed in an extruder, then cooled and calibrated in at least one dry calibration unit and at least one calibration tank, and is then subdivided into individual plastic profiles.

Plastic profiles are produced in extrusion lines in which an extruder first pushes out an initially hot and plastically deformable profile strand, which is then processed in calibration tools into a plastic profile with precisely defined geometric properties. The adjustment of such an extrusion line is very time-consuming as a large number of parameters have to be defined for the individual tools. These parameters interact in a complex way to produce a product with certain properties. The operation of such extrusion lines requires qualified personnel in order to keep waste to a minimum. However, it is often the case that slightly altered environmental conditions cause undesirable characteristics of the plastic profile produced, so that large quantities of faulty plastic profiles may be produced if the need for improved adjustment is not immediately noticed and appropriate corrective action is not taken.

A particularly difficult task is the readjustment of an extrusion line, which is necessary when significant changes are made, especially when a different plastic profile is to be produced. Even if empirical values for favorable setting parameters are already available under similar circumstances, it is often difficult to achieve a stable manufacturing process quickly and efficiently.

It is the object of the present invention to avoid the above-mentioned disadvantages and to specify a method which, on the one hand, makes it possible to make optimum use of existing empirical values on extrusion processes in order to be able to carry out the initial adjustment process quickly and efficiently and, on the other hand, to optimally manage an ongoing extrusion process.

According to the invention, these objects are solved by providing a central control unit which is connected to the tools and, on the one hand, receives data from said tools to uniquely identify the tool and, on the other hand, data on the state of the tool, and which transmits back adjustment data for this and other tools.

One aspect of the present invention is the direct use of measurements determined at the tools and of data on the tools to determine adjustment data. It has been recognized that tools of the same type do not necessarily behave in the same way in an extrusion line due to imperceptible differences in real operation. Therefore, it is essential for the invention that each tool is uniquely identifiable and that all relevant adjustment data relating to this tool are managed accordingly.

In the context of this invention, all components of the extrusion line are referred to as tools. The measured values that result from the data are, for example, temperature, pressure, flow rates and the like at various points on the extruder, the dry calibration units, the calibration tanks and the like.

The adjustment data here are, for example, the extrusion speed, and in general all settings of valves, pumps and the like that enable the control of an extrusion line.

An important aspect of the present invention is that the tools are connected as directly and unmistakably as possible to the supply devices for water or vacuum and to the control unit, so that the integrity of the data is guaranteed.

In accordance with a particularly favorable embodiment variant of the present invention, it is provided that the control device has a database in which a large number of adjustment data are stored and that this database will be used for determining the adjustment data. This database is constantly being expanded and supplemented within the framework of the use of the corresponding tools, so that the amount of usable empirical values is constantly increasing.

A particularly clear and comprehensible determination of the adjustment data can be achieved by creating an extrusion model from the data stored in the database, which is used to determine the adjustment data. The extrusion model depicts the fundamental relationships between the adjustment data and the resulting measured values, thus enabling targeted intervention when the extrusion process is in an unsatisfactory state.

Adjustment data are preferably output in the form of correction values. Such correction values consist, for example, in a certain increase in a quantity of cooling water at a certain point of a certain tool. For example, it may be provided that a correction value concerns the extrusion speed. For example, it is also possible that a correction value may concern the selective cooling of parts of the profile cross-section in the area of the extruder die or that a correction value may concern the control of the cooling water flow in at least one section of the calibration tank.

The present invention also relates to a device for the production of plastic profiles in an extrusion line consisting of several tools, in which at least one dry calibration unit and at least one calibration tank arranged on a calibration table are provided downstream of an extruder.

It is provided according to the invention that a control unit connected to several tools is provided.

It is particularly advantageous if at least one tool is connected to the calibration table via direct connections. In conventional extrusion lines, for example, the dry calibration units are connected via hoses to the water or vacuum connections of a supply device, which is typically located in the calibration table. As a result, it is not possible to make a clear assignment between the tool and the supply device or this is subject to errors.

The direct connection preferably includes both water and vacuum as well as data communication. In this way, not only is the risk of faulty connections reduced, but the conversion of an extrusion line can also be carried out particularly quickly and efficiently, since essentially only a mechanical connection of a tool to the calibration table is required to ensure full functionality.

A particularly favorable solution in terms of design is for at least one dry calibration unit to have a support surface with standardized connections corresponding to the relevant connections on the calibration table.

The flexibility of the device can be increased in particular in that the calibration table has a detection device for unused connections. Not every tool necessarily has the same number of connections and a different number of tools are also used depending on the profile geometry. The detection device thus ensures that, for example, water cannot escape, as unused connections are automatically shut off. The same applies to vacuum.

Particularly high energy efficiency can be achieved by at least one dry calibration unit having several water circuits that are separated from each other. The cooling channels of the dry calibration units typically have different cross-sections. It is therefore necessary to set the pressure at which the cooling water is made available to the most unfavorable section. Likewise, only one temperature level is available for the cooling water. Within the framework of the solution according to the invention, several water circuits are now provided in which both the quantities and the temperatures of the cooling water flowing through them can be set differently. In particular, it is thus possible to cool certain large-area regions of the profile through adjacent cooling water boreholes with large cross-sections, wherein cooling water with relatively low flow velocity is used at moderately low temperatures. Critical profile sections, such as extremities with sealing grooves and the like, on the other hand, are surrounded by comparatively fine cooling water holes, which are exposed to cooling water at high pressure and very low temperature. As only a small amount of high pressure, low temperature cooling water needs to be provided, significant energy savings can be achieved.

A particularly practical solution is provided in that a cooling device is provided in the calibration table which provides water with particularly low temperatures for at least one cooling circuit. This makes it possible to take the majority of the cooling water from a general supply device and to condition only a small part of it in the plant itself, i.e. in the cooling table.

It is advantageous if the calibration tank on the calibration table can be moved in the longitudinal direction. This makes it very easy to adjust the extrusion line if a different number of dry calibration units are used.

In the following, the present invention will be explained in more detail on the basis of the embodiment variants depicted in the figures, wherein:

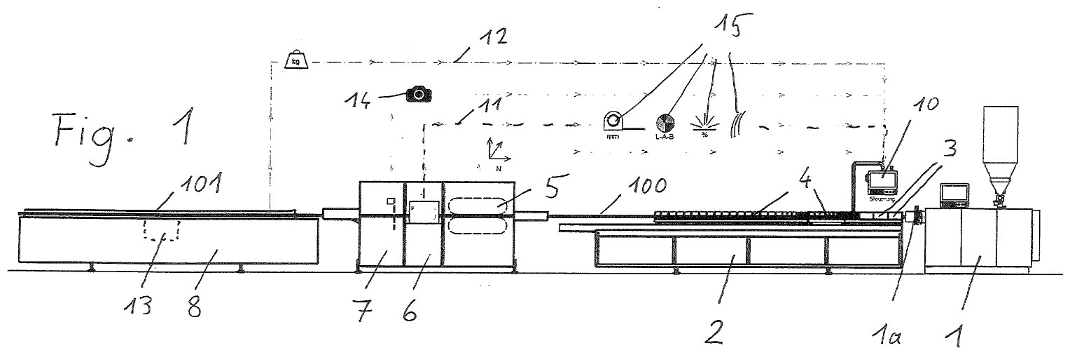

FIG. 1 schematically shows an extrusion line according to the invention;

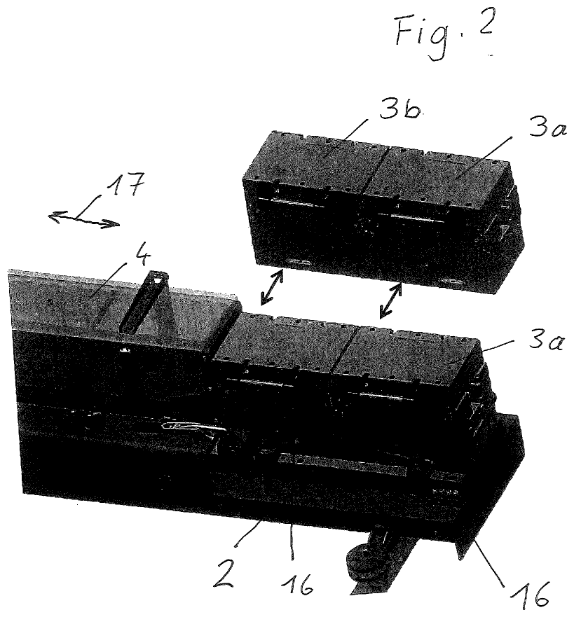

FIG. 2 shows a detail of a calibration table including a dry calibration unit in an oblique view;

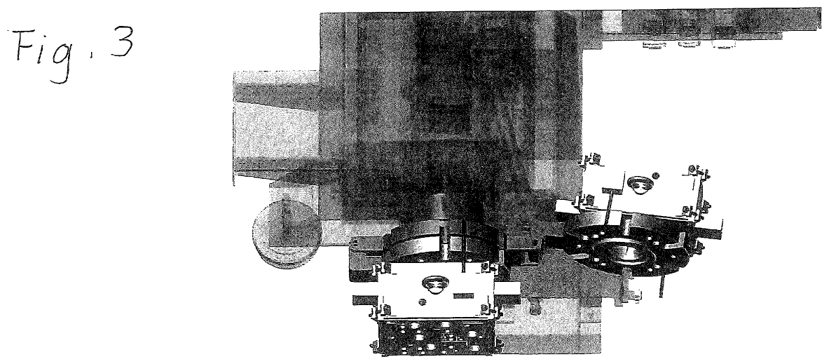

FIG. 3 shows a detail of an extrusion die;

FIG. 4 shows a front view of a dry calibration unit;

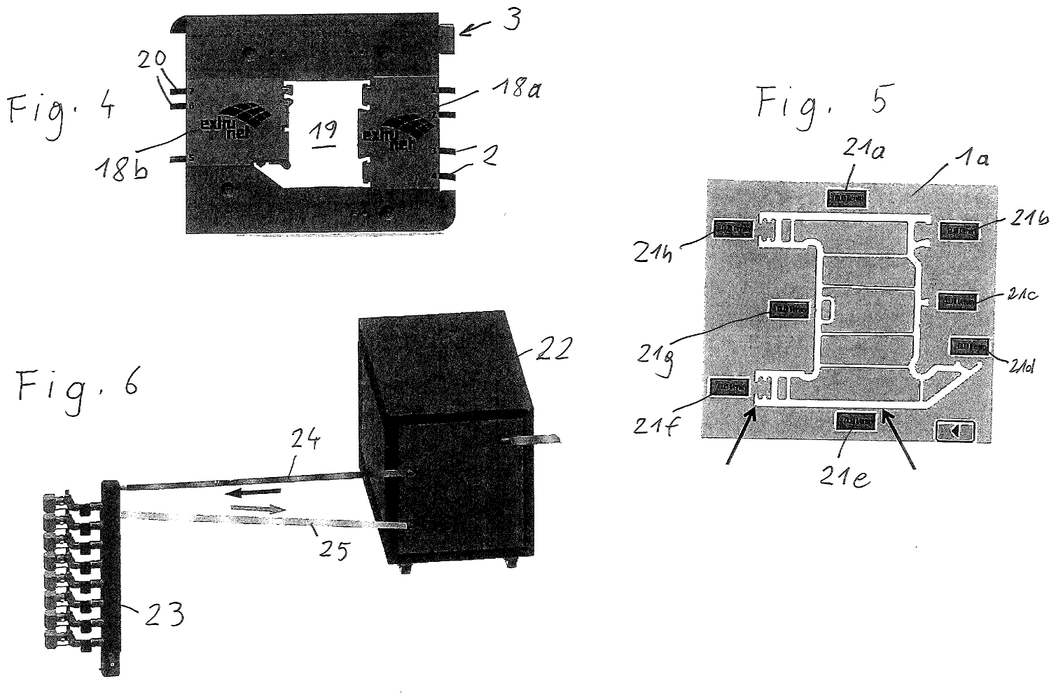

FIG. 5 shows a front view of an extrusion die;

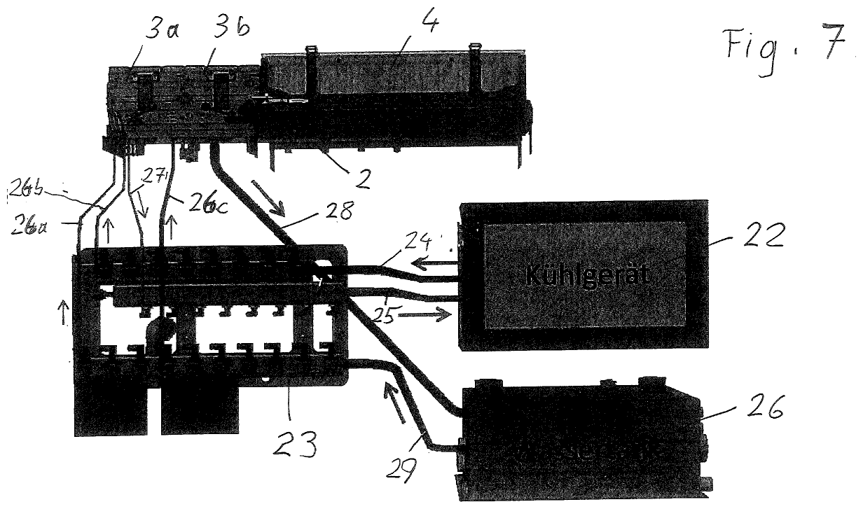

FIG. 6 schematically shows a cooling unit installed in the calibration table; and

FIG. 7 schematically shows the water guidance in the calibration table and the calibration tools.

The extrusion line of FIG. 1 consists of an extruder 1 with an extrusion die 1a, a calibration table 2 arranged downstream thereof, on which several dry calibration units 3 and several calibration tanks 4 (the calibration tools) are arranged to cool and calibrate the plastic profile 100 ejected from the extruder 1.

The calibration tanks 4 can be moved longitudinally on the calibration table 2 to allow quick adaptation to a different number of dry calibration units 3, as it is desirable that the calibration tanks 4 adjoin the dry calibration units 3 directly.

Subsequently, the plastic profile 100 is fed into a caterpillar pull-off 5, which provides the necessary tensile forces to pull the plastic profile 100 through the calibration tools. In a measuring station 6, the plastic profile 100 is measured and then cut in a saw 7 to plastic profiles 101, which are deposited on a tilting table 8.

The extrusion line is controlled by a control unit 10, which is connected to the individual components of the extrusion line via control lines 11, 12. Schematically, a scale 13 is indicated in the tilting table 8, which determines the weight of each plastic profile 101 and transmits it to the control unit 10.

In the same way, the data about the profile geometry and the like are output from the measuring station 6 to the control unit 10. With reference numeral 15, the nature of this data is indicated, namely geometric measurements, color, gloss and scratches. In addition, all relevant data of the other components are transmitted in a manner not described here, such as the pull-off force applied by the caterpillar pull-off 5, measured values of pressure and temperature from the calibration tools and the like, and above all identification data with which each tool can be uniquely identified.

During operation of the extrusion line, the control unit 10 not only accepts data and issues control commands in order to optimally manage the extrusion process, but also records them in a database in order to gain empirical values for subsequent extrusion processes.

FIG. 2 shows that the dry calibration units 3a, 3b can be easily mounted on the calibration table 2, since only a mechanical connection via quick-release fasteners 16 has to be established. All connections are provided on the contact surface on the underside of the dry calibration units 3a, 3b, which is not visible here. They interact with connections at the mounting positions of the calibration table 2 that are also not visible here. Therefore, no hoses are required to connect the calibration tools 3a, 3b, 4 to the calibration table 2, which minimizes the risk of mix-ups or errors.

It is also possible within the scope of the invention to continue to use existing calibration tools in an extrusion line designed in accordance with the invention. A base plate is firmly attached to the underside of these tools, which has the necessary connections on its underside and connects laterally to other connections via internal connecting lines. These additional connections are then connected via connecting hoses to the typically side-mounted connections of conventional calibration tools. The original tool then forms a unit with the base plate and the connecting hoses, which is also no longer separated during dismantling and assembly of the tool. For the purposes of this invention, this unit is regarded as a calibration tool. Again, there is no danger of mix-ups, as there is no further manipulation of the connecting hoses after the initial installation.

FIG. 3 shows a quick-change system for the extrusion die 1a, which can be folded away sideways. Quick-release fasteners combined with preheating of the extrusion die 1a allow an extremely short cycle time of less than 10 minutes when changing the extrusion die 1a.

FIG. 4 shows the end face of a dry calibration unit 3, wherein a die plate 18a, 18b is magnetically fixed on both sides of the opening 19, through which the plastic profile 100 passes. Several dies not visible here can be supplied with compressed air via connections 20 in order to selectively cool the plastic profile 100 entering the opening 19. The air volume is measured to create reproducible conditions. In this way, the wall thickness can be individually adjusted to the outer areas of the plastic profile 100, and the weight of the manufactured plastic profile can be precisely regulated (meter weight).

A similar solution is shown in FIG. 4, in which eight die plates 21a, 21b, 21c, 21d, 21e, 21f, 21g and 21h are also mounted magnetically on the face of an extruder die 1a. The die plates 21a and 21e are aimed at the visible surfaces of the plastic profile 100, while the die plates 21b, 21c, 21d, 21f and 21h are aimed at extremities, which are always a challenge in extrusion processes.

FIG. 6 shows a cooling device arranged in calibration table 2, which cools the general cooling water, which is made available to the extrusion line from the outside, to a lower temperature of 5° C. to 8° C., for example. A distributor 23 is supplied via a flow line 24 and a return line 25, which are used to supply special cooling circuits in the calibration tools.

FIG. 7 shows the general cooling water guidance for the dry calibration units 3a, 3b. The distributor 23 is supplied with general cooling water through a supply line 29 via a water tank 26. In addition, the cooling unit 22 supplies low-temperature water as shown above.

General cooling water at a first pressure level is fed to certain circuits in the dry calibration units 3a, 3b via a first supply line 26a with a small cross-section. A second supply line 26b with a small cross-section leads cooling water of low temperature to further circuits. General cooling water at a further pressure level is supplied via a third supply line 26c with a large cross section. Return lines 27, 28 return the used cooling water.

1. A method for producing plastic profiles in an extrusion line consisting of a plurality of tools, the method comprising;
plasticizing and forming a starting material in an extruder;
cooling and calibrating the starting material in at least one dry calibration unit and at least one calibration tank;
subdividing the starting material into individual plastic profiles;
communicatively coupling a central control unit to the plurality of tools;
receiving at the central control unit is data from the plurality of tools to uniquely identify the tool and data on the state of the plurality of tools; and
adjusting the plurality of tools based on transmitted adjustment data from the central control unit.

2. The method according to claim 1, characterized in that the control device has a database in which a plurality of adjustment data are stored, and that this database is used in determining the adjustment data transmitted to the plurality of tools.

3. The method according to claim 2, characterized in that an extrusion model is produced from the data stored in the database, and the extrusion model is used for determining the adjustment data transmitted to the plurality of tools.

4. The method according to claim 1, characterized in that the adjustment data is output to the plurality of tools in the form of correction values.

5. The method according to claim 4, characterized in that a correction value relates to the extrusion speed.

6. The method according to claim 4, characterized in that a correction value relates to selective cooling of portions of a cross-section of the profile in a region of extrusion die.

7. The method according to claim 4, characterized in that a correction value relates to the control of a cooling water flow in at least a section of a calibration tank.

8. A system for producing plastic profiles in an extrusion line comprising:
an extruder;
a calibration table;
a plurality of tools including, at least one dry calibration unit and at least one calibration tank, both the at least one dry calibration unit and the at least one calibration tank are positioned downstream of the extruder and are arranged on the calibration table; and
a control unit communicatively connected to the plurality of tools.

9. The system of claim 8, characterized in that at least one of the plurality of tools is connected to the calibration table (2) via direct connections.

10. The system of claim 9, characterized in that the direct connection between the at least one of the plurality of tools and the calibration table includes both a supply with water and with vacuum as well as data communication.

11. The system of claim 9, characterized in that the at least one dry calibration unit includes a support surface with standardized connections corresponding to associated connections on the calibration table.

12. The system of claim 9, characterized in that the at least one calibration table has a detection device configured and arranged for detecting unused connections.

13. The system of claim 9, characterized in that the at least one dry calibration unit includes a plurality of water circuits separated from one another.

14. The system of claim 13, characterized in that the plurality of water circuits are configured and arranged to regulate the water to different temperatures.

15. The system of claim 13, wherein the calibration table further includes a cooling device configured and arranged to provide water with particularly low temperatures for at least one of the plurality of water circuits.

16. The system of claim 9, characterized in that the at least one calibration tank on the calibration table is configured and arranged to move in a longitudinal direction.

17. The system of claim 9, characterized in that the at least one calibration tank has a support surface with standardized connections which correspond to associated connections on the calibration table.
